(19) United States
(12) Patent Application Publication
(10) Pub. No.: US 2009/0241041 A1
(43) Pub. Date: Sep. 24, 2009

(54) POSITION CODE BASED CONTENT DEVELOPMENT METHOD AND TOOL

(75) Inventors: Andy Cozine, Fairfield, CA (US); Tom Musolf, Mountain View, CA (US); Timothy Fredenburg, Pacifica, CA (US); Tamar Cohen, Oakland, CA (US); Bruce von Kugelgen, Oakland, CA (US); Don Schuerholz, Mill Valley, CA (US)

Correspondence Address: MURABITO, HAO & BARNES, LLP, TWO NORTH MARKET STREET, THIRD FLOOR, SAN JOSE, CA, 95113, US

(73) Assignee: LeapFrog Enterprises, Inc., Emeryville, CA (US)

(21) Appl. No.: 12/052,102

(22) Filed: Mar. 20, 2008

(51) Int. Cl. G06F 3/00

(52) U.S. Cl. 715/762

(57) ABSTRACT

Computerized content development methods and tools are disclosed. In one embodiment, a method includes generating a title by assigning one or more functions to respective portions of one or more position-coded pages through a graphical user interface which does not require a code level programming, and automatically converting the title to a format operable by computing device which interacts with a printed medium of the position-coded pages to perform the functions.

### FIELD OF TECHNOLOGY

This disclosure relates generally to technical fields of consumer electronics. More particularly, embodiments of the present invention relate to a computerized interactive content development tool.

### BACKGROUND

A computing device has been used to provide user interaction with a printed material (e.g., a book, a photograph, etc.). A user may use the computing device shaped like a pen to interact with a position-coded printed medium having unique dot patterns. In general, the dot patterns are used to determine the relative location of a printed or written element on the position-coded printed medium such that the element can be identified.

The following patents and patent applications describe the basic technology and are all herein incorporated by reference in their entirety for all purposes: U.S. Pat. No. 6,502,756, U.S. application Ser. No. 10/179,966, filed on Jun. 26, 2002, WO 01/95559, WO 01/71473, WO 01/75723, WO 01/26032, WO 01/75780, WO 01/01670, WO 01/75773, WO 01/71475, WO 00/73983, and WO 01/16691.

To interact with the position-coded printed medium, an application program (e.g., a programming code) embedded in the computing device executes a title associated with the elements located on the position-coded medium. The title may be a collection of data which is executed by the application program when the computing device interacts with the elements on the position-coded printed medium. In general, the title is generated by collaboration between a content developer 104 and an engineer 106 who may share a content development platform 102, as illustrated in FIG. 1.

The content developer 104 and/or the engineer 106 may use page tools 108, audio tools 116, and programming tools 120 to create the title. The content developer 104 may utilize drawing and/or text files 110 and position-coded pages 112 to produce a position-coded printed medium 114. An art file created by the content developer 104 may be merged to the position-coded printed pages 112 during this process. Additionally, audio tools 116 may be used to assign audio files 118 to the title.

In most instances, the content developer 104 is not equipped with the necessary programming skill to handle the programming tools 120. The programming is typically assigned to the engineer 106 who develops programming code to execute the title. This is typically a manual process. The engineer 106 may utilize sample applications 122 in the process. In many cases, the engineer 106 lacks experience and/or skill in the field of content development. Because their individual specialties, the content developer 104 and the engineer 106 may have to work closely together, thus opening a possibility of miscommunication between the two parties and other inefficiencies (e.g., time and/or manpower).

Furthermore, once the title is completed, a debug and test tool 124 may be used to troubleshoot the title 124. This process may be cumbersome and time-consuming because errors may be located in the content development space and/or the programming space. In the debugging process, if one or more errors are found, the content developer 104 and the engineer 106 may have to exert additional efforts to redo the title.

### SUMMARY

Accordingly, what is needed is more efficient manner of developing content related to position-coded printed media and computer systems that interact therewith. What is further needed is a computerized content development tool that has a graphical user interface which allows a content developer with little specialized programming skill to design and then automatically program a title to be played by a computing device when interacting with the position-coded printed media.

One embodiment of the present invention pertains to a method for position code based content development. The method includes generating a title by assigning one or more functions to respective portions of one or more position-coded pages as depicted through a graphical user interface which does not require a code level programming, and automatically converting the title to a format operable by a computing device which interacts with the portions of the printed medium of the position-coded pages to perform the functions. In one embodiment, the computer system is a pen based computer system.

Another embodiment of the present invention pertains to a machine readable medium containing instructions that, when executed by a machine, executes the process listed above. Yet another embodiment pertains to a computerized content development tool having a graphical user interface for generating a title based on one or more functions assigned to respective portions of one or more position-coded pages. By using the tool, the title is automatically transformed into a format operable by a computing device and the functions are invoked when the computing device, embedded with the title, interacts with a printed medium corresponding to the title.

As illustrated in the detailed description, other embodiments also pertain to methods and tools that provide a user-friendly graphical user interface which enables the user to author a title based on the position-coded technology with reduced development time and/or more organized manners.

By using the computerized development tool in accordance with the present invention, a content designer can directly interface with a graphical user interface to create illustrations of a page and to assign functionality to these illustrations as would be executed by a pen based computer interacting with the illustrations. In one embodiment, play rules can be defined for different illustrations and sounds and specific feedback can be programmed using the graphical user interface. The tool then automatically creates a digital output representing the title which can be downloaded to the pen based computer.

### BRIEF DESCRIPTION OF THE DRAWINGS

Example embodiments are illustrated by way of example and not limitation in the figures of the accompanying drawings, in which like references indicate similar elements and in which:

FIG. 1 is a conventional art illustration of a development system for a title of a pen based computer system.

FIG. 2A is an exemplary system view of a computerized content development tool having a graphical user interface, according to one embodiment.

FIG. 2B is an exemplary system view of a computerized content development tool with a code generation module, according to one embodiment.

FIG. 3 is an exemplary flow chart of a content development process realized with the computerized content development tool of FIG. 2, according to one embodiment.

FIG. 4 is an exemplary graphical user interface of the computerized content development tool of FIG. 2, according to one embodiment.

FIG. 5 is an exemplary view of the navigator pane of the graphical user interface of FIG. 4, according to one embodiment.

FIG. 6 is an exemplary view of the authoring pane of the graphical user interface of FIG. 4, according to one embodiment.

FIG. 7A is an exemplary view of the graphical user interface of FIG. 2 with a graphical editor, according to one embodiment.

FIG. 7B is an exemplary view of the graphical user interface of FIG. 2 with a comma separated value (CSV) style editor, according to one embodiment.

FIG. 7C is an exemplary view of the graphical user interface of FIG. 2 creating an activity, according to one embodiment.

FIG. 7D is an exemplary view of the graphical user interface of FIG. 2 with customized defaults for an activity, according to one embodiment.

FIG. 8 is an exemplary process flow chart for generating a title associated with a position-coded printed medium, according to one embodiment.

Other features of the present embodiments will be apparent from the accompanying drawing and from the detailed description that follows.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the Claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

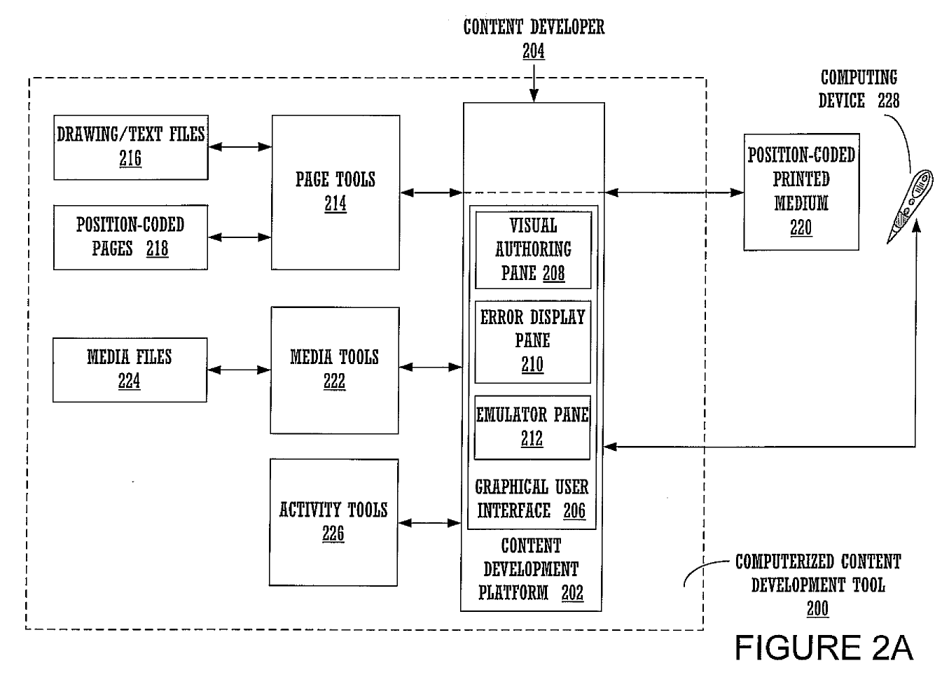

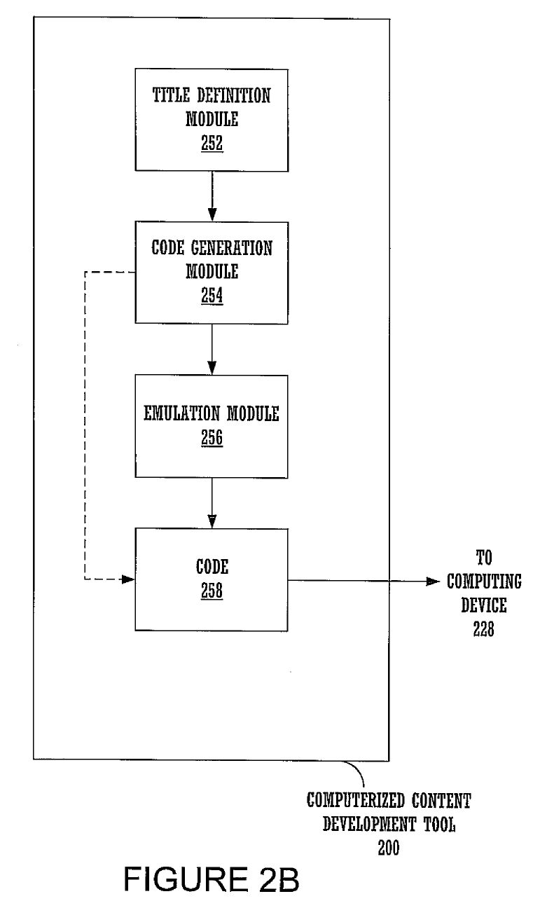

FIG. 2A is an exemplary system view of a computerized content development tool 200 having a graphical user interface 206, according to one embodiment. As illustrated in FIG. 2A, the content development tool 200 is a software program operable on a computer system and provides a content development platform 202 equipped with a graphical user interface 206. In one example embodiment, the user friendly nature of the graphical user interface 206 may enable a content developer 204 to develop a title operable, for instance, on a pen based computer, end-to-end without any collaboration with an engineer (e.g., a software programmer). An authoring pane 208, an error display pane 210, and an emulator pane 212 may be some of the many features available in the computerized content development tool 200 to realize that goal. The title is ultimately resident on the computing device 228 (e.g., pen based) and drives the experience of a user interacting with a printed medium.

Page tools 214 may utilize drawing and/or text files 216 and position-coded pages 218 to produce a position-coded printed medium 220 having illustrations printed therein. Drawing files and/or text data may be merged to the position-coded pages 218 during this process.

Additionally, media tools 222 may be used to assign media files 224 (e.g., audio files, video files, tactile files, etc.) to the title. The media files 224 may be seamlessly embedded to the title (e.g., with specific functionality) by using the graphical user interface 206 (e.g., the authoring pane 208). When portions (e.g., regions) of the position-coded printed medium 220 are invoked (e.g., by touching, dragging, etc.) by a computing device 228 (e.g., pen-shaped), the media files 224 embedded in the portions are played back via the computing device 228 (e.g., thus providing audio, visual, and/or tactile feedbacks). Play logic, built into the tile, determines the playback sequence and/or playback content related to a particular region.

As for the audio feedback, the computing device 228 may generate an audio sound. The computing device 228 may also optionally display a video through a display panel installed on the computing device 228. Additionally, the computing device 228 may optionally provide a tactile feedback associated with a particular region of the position-coded printed medium (e.g., based on the haptic technology).

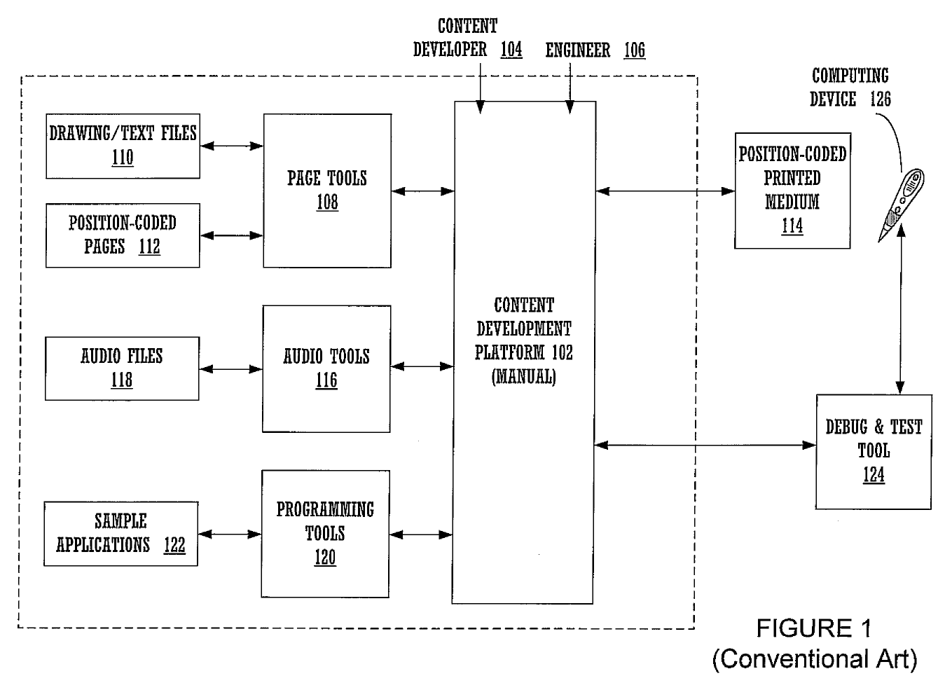

Activity tools 226 may be used to assign activities (e.g., a question and answer set related to the regions, etc.) to the title in the form of play logic. Unlike the system described in FIG. 1, the computerized content development tool 200 does not require a user (e.g., the content developer 204) to perform low level programming of the title using programming tools. Instead, the computerized content development tool 200 enables the content developer 204 to generate the title in a user-friendly way such that the content developer 204 can complete the task of generating the title end-to-end without any help from an engineer.

Furthermore, the error display pane 210 may generate error messages due to the usage of the graphical user interface 206 when the content developer 204 interacts with the page tools 214, the media tools 222, and/or the activity tools 226, thus providing guidance to the content developer 204. Additionally, the emulator pane 212 enables the content developer 204 to emulate the title in a PC environment, thus malting it easier to troubleshoot the title. Emulation can be performed via the developer interfacing with regions on a computer screen, via a mouse, to simulate a pen computer interacting with the printed medium.

FIG. 2B is an exemplary system view of a computerized content development tool 200 with a code generation module 254, according to one embodiment. As illustrated in FIG. 2B, the computerized content development tool 200 may also include a title definition module 252, the code generation module 254 and an emulation module 256. The title definition module 252 enables the content developer 204 to assign one or more functions to respective portions of position-coded pages via the visual authoring pane 208. The code generation module 254 automatically converts the developer's selections to a computer code that is stored in memory. The emulation module 256 may be used to enable the content developer 204 to emulate the functions on the portions of the title using a cursor moving device and/or a computer screen.

Once the content developer is content with the title, the code 258 is embedded (e.g., by inserting a cartridge to the computing device 228 or by directly downloading the title) to the computing device 228. The title at this point of time may comprise audio data, region data, and resource data pertaining to activities, questions, answers, timers, and/or other features available in the title. In an alternative embodiment, the title has only data but no programming code. In this embodiment, the data is read and implemented using a special reader tool resident on the pen computer.

The computing device 228 may be able to interact with the position-coded printed medium 220 by executing the title with an application program. In one example embodiment, the application program or reader (e.g., with a standard data set) may be a standard feature of the computing device 228 regardless of the title and reads the title to implement it. The application program may execute the title, accept inputs of the user, and/or take appropriate actions described by the title.

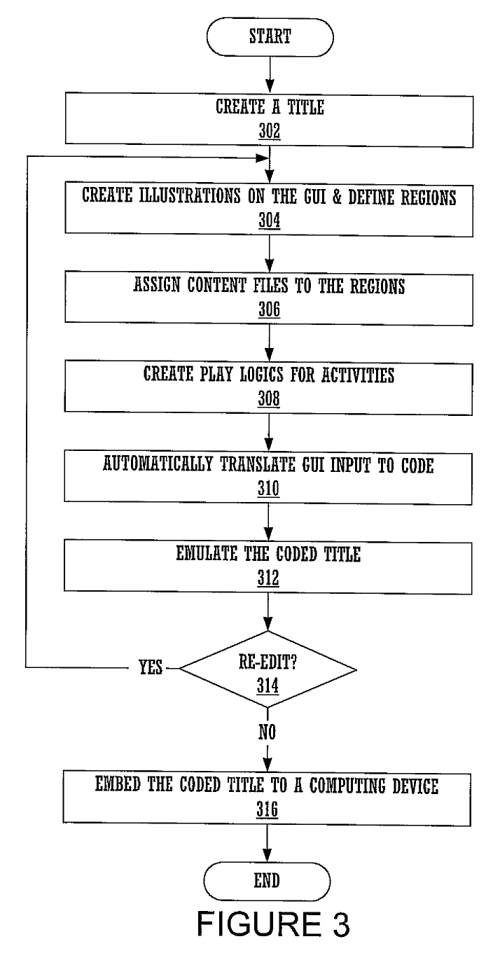

FIG. 3 is an exemplary flow chart of a content development process realized with the computerized content development tool 200 of FIG. 2, according to one embodiment. In operation 302, a title is created by assigning properties (e.g., a name, a comment, an identification, a logging level, and/or a locale) to the title. In operation 304, one or more illustrations may be created on the graphical user interface 206 of the computerized content development tool 200. The illustrations may be loaded by scanning from a legacy printed medium (e.g., an old book) and/or from an electronic file (e.g., an e-book). Alternatively, the illustrations may be newly generated.

In operation 306, one or more media files 224 (e.g., content files) may be assigned to the regions. In operation 308, play logics may be crated using the graphical user interface 206 (e.g., the activity tools 226) for activities. In operation 310, the input to the graphical user interface 206 may be automatically translated (e.g., built) into code. During the translation operation, all of the human-readable strings (e.g., the title name, touch and respond set names, activity names, etc.) associated with the title may be packed to enable the computing device 228 uniquely identify the components, thus transforming the title to a format operable by the computing device 228. As a result, when the computing device 228 interacts with the position-coded printed medium (e.g., which corresponds with the title), one or more functions (e.g., touch and responds, activities, etc.) may be invoked in accordance with the title.

In operation 312, the title is emulated on the development tool platform 202 to facilitate rapid prototyping and/or to reduce hardware dependencies. In order to do that, the emulator pane 212 of the computerized content development tool 200 may enable the content developer 204 to test and/or debug the title on a computer using a display screen and a cursor directing device (e.g., which may be running the computerized content development tool 200 at the same time) rather than requiring the computing device 228 to test and/or debug the title. In this embodiment, the mouse of the computer (e.g., a personal computer, a laptop computer, a PDA, etc.) may replace the computing device 228 while the screen of the computer replaces the position-coded printed medium 220.

Based on the result of operation 312, the title is re-edited in operation 314. Once the content developer 204 is satisfied with the title, the coded title or packed title is embedded to the computing device 228 in operation 316. If the content developer 204 is not satisfied with the title, some or all of operations 304, 306, 308, 310 and 312 may be repeated.

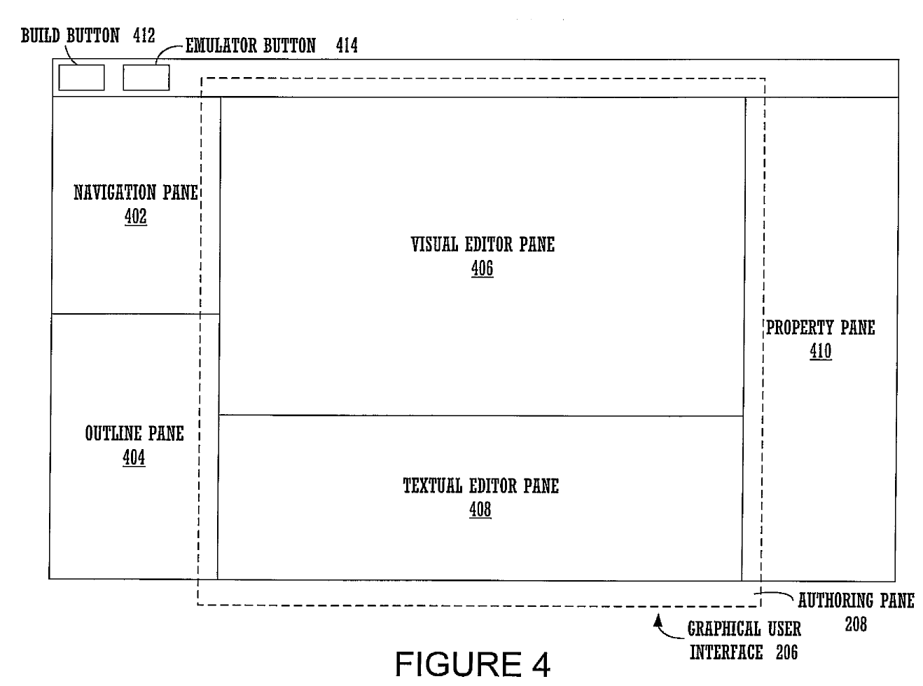

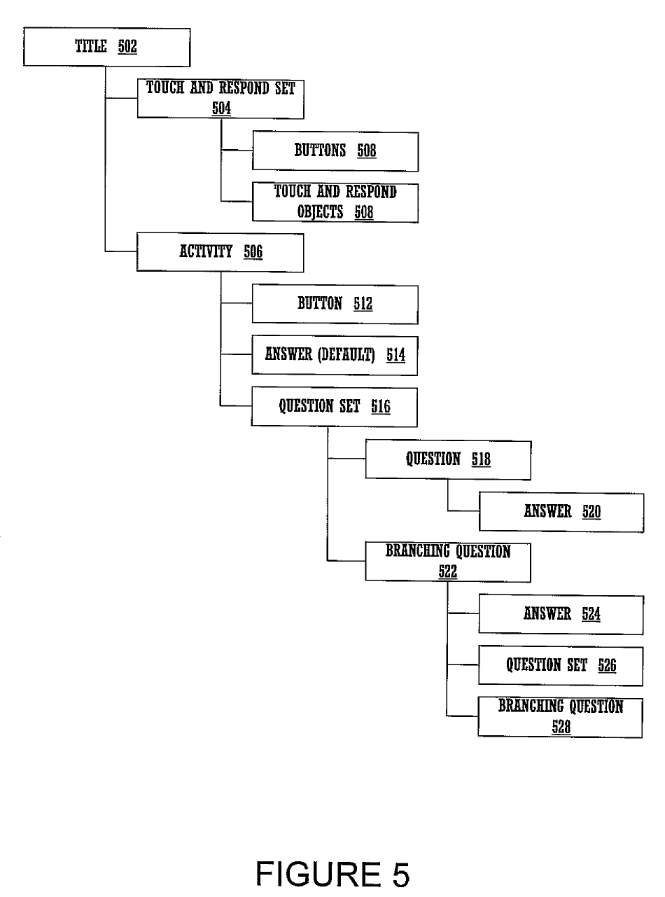

FIG. 4 is an exemplary graphical user interface 206 of the computerized content development tool 200 of FIG. 2, according to one embodiment. As illustrated in FIG. 4, the graphical user interface 206 includes a navigator pane 402, an outline pane 404, a visual editor pane 406, a textual editor pane 408, a property pane 410, a build button 412, and an emulator button 414. The navigator pane 402 may present objects in a nested hierarchy to facilitate easy discovery or simulation and association of the title, touch and respond sets, activities, buttons, questions, and/or answers, as will be illustrated in details in FIG. 5. The outline pane 404 may display a list of objects embedded to the page displayed on the visual editor pane 406.

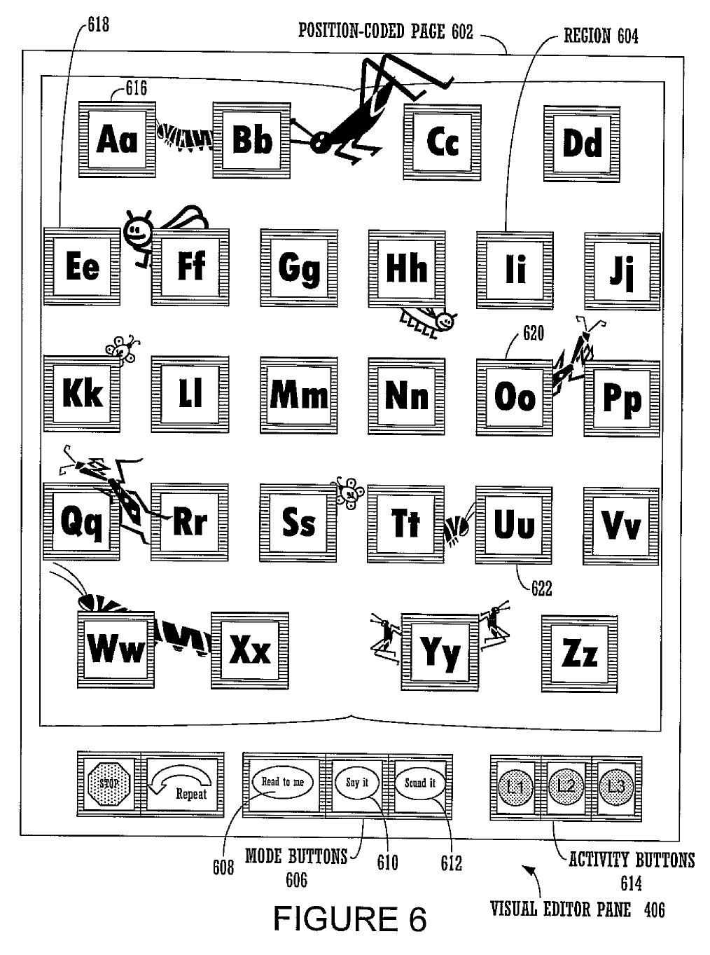

The visual editor pane 406 may enable a content developer (e.g., the content developer 204) to embed media files (e.g., the media files 224) and/or activities to portions (e.g., regions) on one or more position-coded pages (e.g., the position-coded pages 218), as will be illustrated in details in FIG. 6. The visual editor pane 406 therefore presents a visual depiction of a typical page of the constructed title with associated illustrations. The textual editor pane 408 may display information of the regions displayed on the visual editor pane 406, properties of activities associated with the position-coded pages and regions displayed on the visual editor pane 406, one or more errors committed by the content developer while using the graphical user interface 206, tasks, and/or the progress of the title being authored. Additionally, any problem condition which may require an intervention by the content developer may be presented by a pop up dialog and/or another type of problem view.

The property pane 410 may display the property of any region and/or an object (e.g., a media file, etc.) selected by the content developer and/or enable its modification. The build button 412 may enable the content developer to package all of the human readable strings that the application program in the computing device 228 needs to uniquely identify title components of the title including but not limited to the name of the title, names of the touch and respond set, and activity names.

The emulator button 414 may facilitate a rapid prototyping and/or reduce hardware dependencies of the title by enabling the content developer to test and/or debug the title on a personal computer equipped with a screen and a mouse. To the fullest extent possible, the emulator pane 212 (e.g., which may be a pop-up) of the graphical user interface 206 may run the title (e.g., in flash) as if the title was running on the computing device 228 interacting with the position-coded printed medium 220. In the emulator setting, the mouse and the screen of the personal computer may replace the computing device 228 and the position-coded printed medium 220, respectively.

FIG. 5 is an exemplary view of the navigator pane 402 of the graphical user interface 206 of FIG. 4, according to one embodiment. The navigator pane 402 may present objects in a nested hierarchy to facilitate easy discovery and association of a title 502, a touch and respond set 504, and/or an activity 506. A wizard may be used to create new objects (e.g., a title, a button, a touch and respond set, an activity, a question, an answer, and/or various types of buttons). A wizard for the title 502 may enable the content developer to create an empty title without using a template and/or create a title populated with contents from the selected templates.

The touch and respond set 504 may define one or more touch and respond objects 510 and buttons 508 associated with the touch and respond objects. The touch and respond set 504 may be created by associating regions and media files (e.g., audio file, video files, tactile files, etc.) by using functions available through the authoring pane 208. The content developer may graphically create new touch and respond regions and assign media files to the regions or change the association between existing regions and media files embedded in the regions to modify the touch and respond regions. The process may be performed through graphically by using the visual editor pane 406, as will be illustrated in more details in FIG. 6 or through textually by using the textual editor pane 408. The buttons 508 may include a stop button (e.g., to stop audio playback), a repeat button (e.g., to repeat the last audio), and an always active button (e.g., which plays an audio response). The term “touch and respond” describes the characteristic of the widgets which perform the embedded functions when invoked. For example, the stop button may “respond” (e.g., stop) the audio playback when “touched” (e.g., pressed) by a user.

The activity 506 may be implemented according to a predefined play pattern. A wizard may be lunched to create an activity file. A filename, a timer, an answer (e.g., a default answer) 514 for the activity 506 as well as a button 512 and a question set 516 associated with the activity 506 may be configured by using the wizard. The content developer may choose to create an empty activity with no question sets where defaults would be taken from the title 502. Alternatively, the content developer may choose to create a prepopulated activity where the content developer can specify how many questions sets and/or answers to generate.

The button 512 may include an activity button (e.g., which starts an activity) and other buttons. The question set 516 (e.g., and/or a question set 526) may be an ordered group of one or more questions. A question 518 may prompt the user (e.g., of the title 502) to touch one or more answers in an activity. An answer 520 (e.g., and/or an answer 524) may be a touchable response to one or more questions in an activity. A branching question 522 (e.g., a branching question 528) may be a question that branches the navigation flow of the title 502.

FIG. 6 is an exemplary view of the visual editor pane 406 of the graphical user interface 208 of FIG. 4, according to one embodiment. In FIG. 6, the visual editor pane 406 provides a way for a content developer to graphically edit touch and respond objects and activities associated with a position-coded page 602 (e.g., with a drawing and various regions assigned to the position-coded page 602). The content developer may drag and/or drop to add one or more media files (e.g., once the media files are located from the navigator pane 402) to a region 604 to associate the title to the region. Alternatively, the content developer can drag and drop the media files onto the property pane 410 allotted for the region 604.

Mode buttons 606 may define a mode of the touch and respond sets of the position-coded page 602. A read to me 608 may play back the story text of the position-coded page 602 with background audio and sound effects. A say it 610 may play back the audio of one or more words associated with the region 604. And, a sound it 612 may play back phonemes associated with the region 604.

One or more activities (e.g., represented by activity buttons 614) also called play logics may be created in association with various regions of the position-coded page 602. The activities may contain question sets, timers, buttons, and other features. The outline pane 404 may be used to view the activities where the content developer can easily see, create, and/or modify contents of the activities.

The visual editor pane 406 may enable the content developer to associate the various regions with the activities' answers. To create the answers, the content developer may first select the question (e.g., or any other type of activity) from the outline pane 404. Before this step is taken place, the question may be newly created or loaded from a legacy activity. The user may then select the type of answers to be created (e.g., correct, wrong, etc.) The content developer may then click on one or more regions. Once the answer is selected and its region is activated, the content developer may then drag and drop a media file (e.g., an audio file) into the region for that answer. The audio then becomes the touch audio for that answer to render the “correct” or “wrong” outputs.

For example, an activity may have a question which asks “which alphabets are vowels?” To create the answers to the question, the content developer first selects “correct” as the type of answer for “Aa” 616, “Ee” 618, “Ii” 604, “Oo” 620, and “Uu” 622. For the remaining regions, the type of answer is set as “wrong.” Once this step is completed, audio files (e.g., which sounds the phoneme associated with each region) may be dragged and dropped to the regions.

In one example embodiment, a spread view of the visual edit pane 406 may allow two or more pages shown side by side. Aside from the visual editor pane 406, the touch and respond sets and/or the activities may be edited by using the textual editor pane 408.

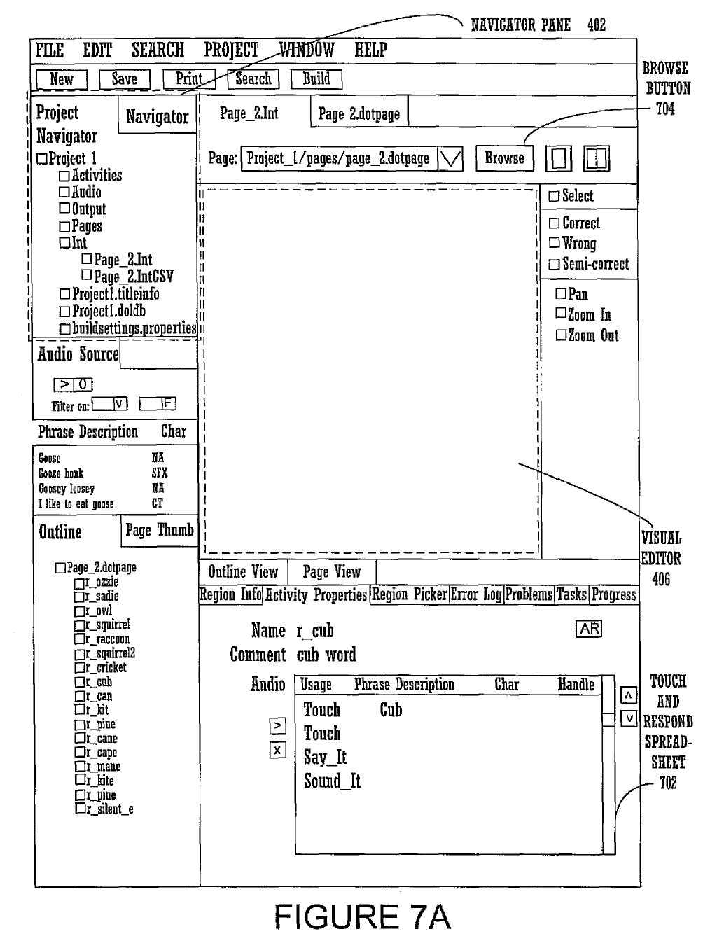

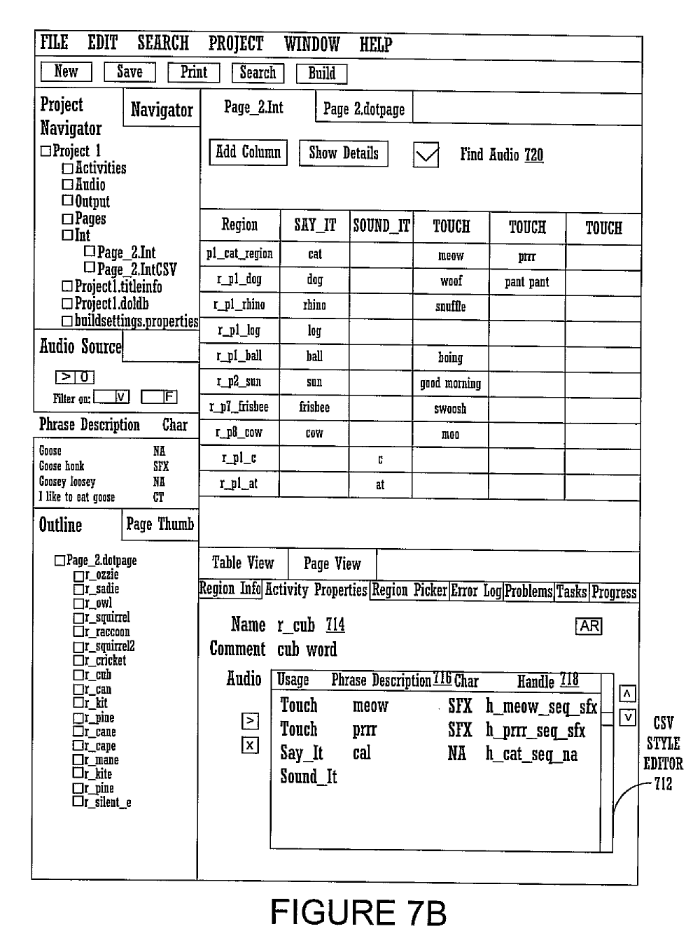

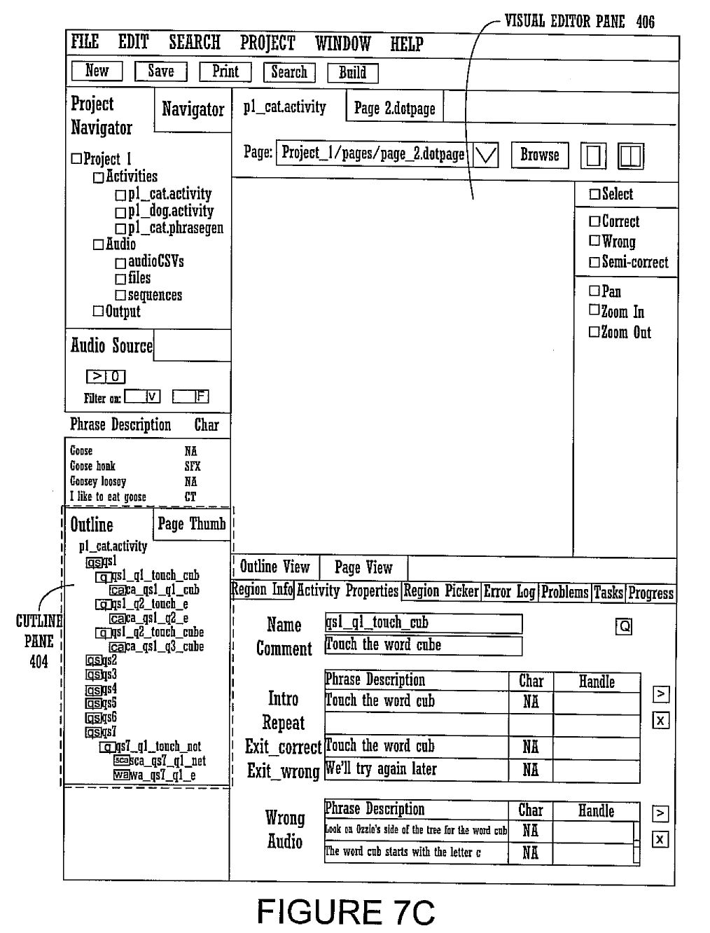

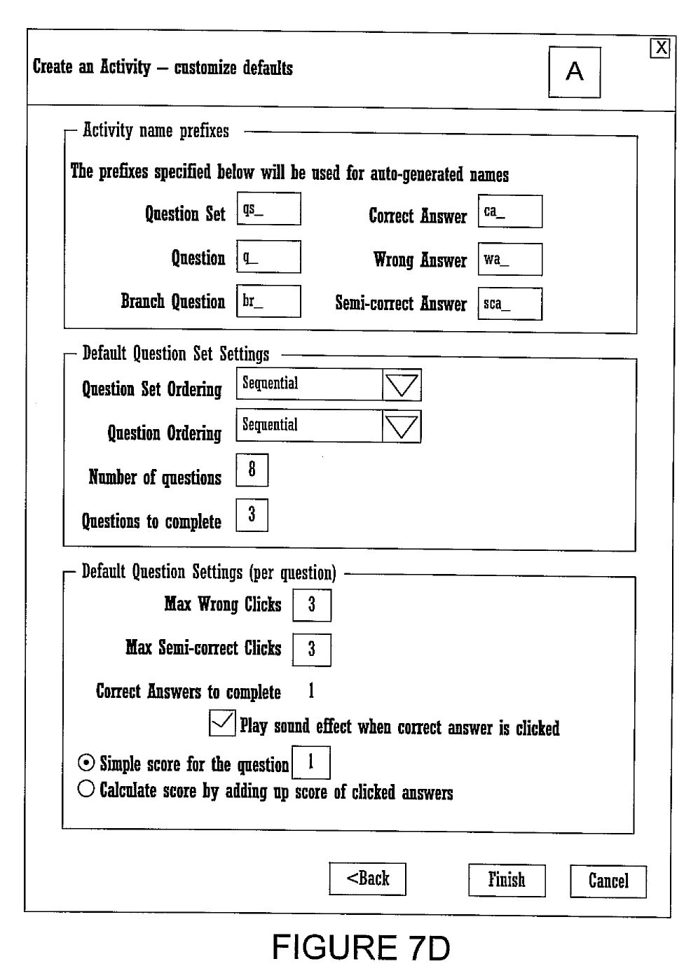

FIG. 7A is an exemplary view of the graphical user interface 206 of FIG. 2 using a graphical editor, according to one embodiment. In FIG. 7, the visual editor pane 406 provides a way for a user to graphically fill out a touch and respond spread sheet 702 while looking at the regions on the page. A touch and respond set file may reference more than one page. To access regions on different pages, the user may use a browser button 704, type the page name or drag and drop the page from the navigator pane 402 into the visual editor pane 406. The “touch,” “say_it,” “sound_it” and “spell_it” palette entries may be mutually exclusive mode buttons. The default is the “touch.” The mode defines the touch mode the user is configuring.

Once the mode is selected, the regions already active in the mode may be highlighted in some color. The user may drag and drop from the audio source view to add audio of the selected mode to a region, or the user can drop onto the activity properties view. The visual editor pane 406 may show two or more pages at once.

FIG. 7B is an exemplary view of the graphical user interface 206 of FIG. 2 using a comma separated value (CSV) style editor 712, according to one embodiment. The CSV style editor 712 allows the user to do a CSV style of editing for touch and respond buttons or sets. The file described by the name of “r_cub” 714 stores a phrase description 716 and a handle 718. If “find audio” 720 is checked, an audio region information view functionality to find and populate or create audio is enabled. Each of these rows represents one unique region. If more than one region have the same touches, the rows may be duplicated.

FIG. 7C is an exemplary view of the graphical user interface 206 of FIG. 2 creating an activity, according to one embodiment. One activity may be defined per single activity file. Each activity may contain question sets, questions, timers, etc. One way of viewing an activity is via the outline pane 404 where the user can easily see, create and/or modify contents of the activity.

The other step is associating regions with the activity's answers. The only types of things that can have regions associated with them within an activity are answers. The user can click the page view tap 722 on the bottom of the activity editor to get into his graphical mode of viewing an activity. If the activity has any regions assigned to it, the first page that is referenced is shown. Otherwise there is a dropdown to switch to a different page, or the user can browse or drag/drop a new dotpage to begin associating it with its regions.

To create answers, the user first selects a question from the outline pane 404. The user then selects the type of answers to be created (e.g., correct or wrong). The user than clicks on one or more regions. This creates individual auto-named answers for each region clicked.

The user may delete an answer entirely from the outline pane 404. In addition, when the user selects different answers, questions and/or question sets, the regions visually change to reflect which ones have already been assigned. Moreover, if an answer is selected, and its regions are activated, then the user can drag and drop an audio onto the region for that answer. The audio then becomes the touch audio for that answer. If a region is used in only one answer and is not selected, the user is presented with a dialog to select which answer to use. The user may also drag and drop the audio into the list of audio in the answer properties.

FIG. 7D is an exemplary view of the graphical user interface 206 of FIG. 2 with customized defaults for an activity, according to one embodiment. As illustrated in FIG. 7D, default question settings are populated based on title settings. The settings are then stored as defaults for the activity itself. When new questions are created, the questions have these settings as the defaults. There are two ways to score a question, either via the simple score or via adding up the answer scores. If the user clicks finish at this point, the activity will have customized question set/question defaults but will be created based on the previous page settings.

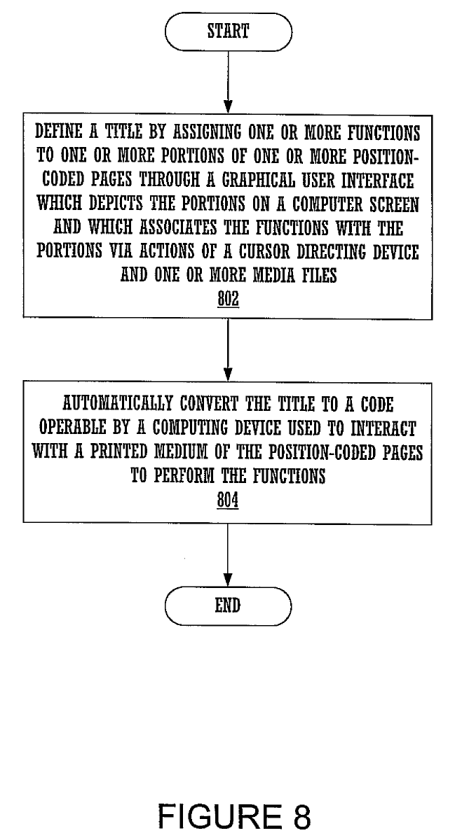

FIG. 8 is an exemplary process flow chart for generating a title associated with a position-coded printed medium, according to one embodiment. In operation 802, a title is generated by assigning one or more functions to respective portions of one or more position-coded pages through a graphical user interface which depicts the portions on a computer screen and which associates the functions with the portions via actions of a cursor directing device and one or more media files. In operation 804, the title is automatically converted to a code operable by a computing device used to interact with a printed medium of the position-coded pages to perform the functions. Moreover, the process described in operations 802 and 804 may be coded to a machine readable medium, and may be performed when the machine readable medium is executed by a machine (e.g., a computer, etc.).

In one example embodiment, the position-coded pages may be newly created (e.g., after getting a license) or loaded by scanning from a legacy printed medium or from an electronic file. In another example embodiment, each of the respective portions may be generated by forming a polygon shaped region on the position-coded pages. Media files may be assigned to the respective portions (e.g., by dragging and dropping the media files to the respective portions). Furthermore, one or more activities associated with the position-coded pages may be assigned to the respective portions.

In yet another example embodiment, one or more error messages may be generated based on a user input to the graphical user interface. Additionally, the title may be emulated on a computer system.

The previous description of the disclosed embodiments is provided to enable any person skilled in the art to male or use the present invention. Various modifications to these embodiments will be readily apparent to those skilled in the art, and the generic principles defined herein may be applied to other embodiments without departing from the spirit or scope of the invention. Thus, the present invention is not intended to be to be accorded the widest scope disclosed herein.

What is claimed is:

1. A computer implemented method for position code based content development, comprising:
defining a title by assigning at least one function to at least one portion of at least one position-coded page through a graphical user interface which depicts the at least one portion on a computer screen and which associates the at least one function with the at least one portion via actions of a cursor directing device and at least one media file; and
automatically converting the title to a code operable by a computing device, wherein the computing device is operable to interact with a printed medium of the at least one position-coded page to perform the at least one function.

2. The method of claim 1, wherein the title comprises audio data, region data, and resource data.

3. The method of claim 1, wherein the computing device comprises a pen based computer system to execute the code.

4. The method of claim 1, wherein the at least one position-coded page is merged with a drawing file and text data to generate the printed medium.

5. The method of claim 4, wherein the defining the title further comprises loading the at least one position-coded page by at least one of: scanning from a legacy printed medium; opening an electronic file; and newly generating the at least one position-coded page.

6. The method of claim 4, wherein the defining the title further comprises generating the at least one portion by forming a polygon shaped region on the at least one position-coded page.

7. The method of claim 6, wherein the assigning the at least one media file is performed by dragging and dropping the at least one media file to the at least one portion.

8. The method of claim 7, wherein the at least one media file comprises an audio file, a video file, and a tactile file.

9. The method of claim 4, wherein the assigning the at least one function comprises assigning at least one activity associated with the at least one position-coded page to the at least one portion.

10. The method of claim 9, wherein the at least one activity comprises a plurality of questions invoking respective responses.

11. The method of claim 1, wherein the defining the title further comprises generating at least one error message based on a user input associated with the assigning the at least one function.

12. The method of claim 1, wherein the defining the title further comprises emulating the title on a computer system.

13. The method of claim 1, wherein the converting the title further comprises embedding the code to the computing device.

14. A computer readable medium for position code based content development having
instructions that, when executed by a computer, cause the computer to perform a method comprising:
defining a title by assigning at least one function to at least one portion of at least one position-coded page through a graphical user interface which depicts the at least one portion on a computer screen and which associates the at least one function with the at least one portion via actions of a cursor directing device and at least one media file; and
automatically converting the title to a code operable by a computing device, wherein the computing device is operable to interact with a printed medium of the at least one position-coded page to perform the at least one function.

15. The computer readable medium of claim 14, wherein the defining the title further comprises emulating the title on a computer system.

16. A computerized content development tool, comprising:
a graphical user interface for defining a title based on at least one function assigned to at least one portion of at least one position-coded page as depicted on a computer display of the graphical user interface; and
a code generator for automatically transforming the title into a code operable by a computing device,
wherein the at least one function is invoked when the computing device embedded with the code interacts with the at least one portion of a printed medium corresponding to the title.

17. The computerized content development tool of claim 16, wherein the graphical user interface comprises a visual editor pane used to assign the at least one function to the at least one portion of the at least one position-coded page in response to a use using a cursor directing device to drag and drop the at least one object file to the at least one portion.

18. The computerized content development tool of claim 17, wherein the graphical user interface comprises a build button used to initiate a conversion of the title into the code operable by the computing device.

19. The computerized content development tool of claim 16, wherein the graphical user interface comprises an error display at least one error message associated with the generating the title.

20. The computerized content development tool of claim 16, wherein the graphical user interface comprises an emulator pane used to simulate the title regarding user interactions between the computing device and the printed medium.
